(19) United States
(12) Patent Application Publication
(10) Pub. No.: US 2025/0315482 A1
(43) Pub. Date: Oct. 9, 2025

(54) SYSTEM AND METHOD FOR TASK-AGNOSTIC SEMI-AUTOMATED AGGREGATION OF HISTORIC VEHICLE RAW DATA

(71) Applicant: TOYOTA RESEARCH INSTITUTE, INC., Los Altos, CA (US)

(72) Inventors: RUMEN I. ILIEV, Millbrae, CA (US); David A. SHAMMA, San Francisco, CA (US); Alexandre FILIPOWICZ, Los Altos, CA (US); Nikos ARECHIGA GONZALEZ, San Mateo, CA (US); Chi ZHANG, Los Altos, CA (US)

(73) Assignees: TOYOTA RESEARCH INSTITUTE, INC., Los Altos, CA (US); TOYOTA JIDOSHA KABUSHIKI KAISHA, TOYOTA-SHI (JP)

(21) Appl. No.: 18/627,388

(22) Filed: Apr. 4, 2024

(51) Int. Cl. G06F 16/901; B60R 16/023; B60W 60/00; G06F 16/906

(52) U.S. Cl. CPC G06F 16/9027; G06F 16/906

(57) ABSTRACT

Systems and methods are provided for generating cascaded data structures that can be used, for example, for training models for use in artificial intelligence applications, for example, in for vehicular operation and vehicle usage modeling and analyses. Examples include obtaining raw sensor data from vehicles comprising a first characteristic and iteratively generating intermediate data structures by segmenting data items of an input data structure according to levels of the first characteristic and, for each level, executing one or more transformation functions on the segmented data items to generate a respective intermediate data structure. The input data structure for a first iteration may be the raw data and the input data structure for subsequent iterations may be an intermediate data structure generated by a preceding iteration. Examples also include combining the intermediate data structures to generate the cascaded data structure.

### TECHNICAL FIELD

The present disclosure relates generally to systems and methods for machine learning for semi-autonomous/autonomous vehicular operation, and, more particularly, some embodiments relate to transforming raw vehicle data into cascaded data structures usable to train machine learning models for semi-autonomous/autonomous vehicular operation and vehicle usage modeling and analyses.

### DESCRIPTION OF RELATED ART

Vehicular automation involves the use of mechatronics, artificial intelligence, and multi-agent systems to assist the operator of a vehicle, such as an automobile. A vehicle using automation for certain tasks, such as navigation or maneuver, that assist human control, without fully replacing human control, may be referred to as semi-autonomous. Whereas, a fully self-operated vehicle can be referred to as autonomous. Semi-autonomous/autonomous operation may be achieved through the use of artificial intelligence (AI) or machine learning (ML) to predict and/or implement operational commands or instructions. AI or ML may rely on the creation of models that are trained using training data and the models can be used to make predictions by processing additional input data.

### BRIEF SUMMARY OF THE DISCLOSURE

According to various embodiments of the disclosed technology, systems and methods for transforming raw data collected from vehicle sensors into a cascaded data structure that can be used, for example, in training machine learning models for autonomous and/or semi-autonomous vehicular operations are provided.

In accordance with some embodiments, a method is provided. The method comprises obtaining raw data from sensors of one or more vehicles, where the raw data comprises a first characteristic. The method also includes iteratively generating a plurality of intermediate data structures by segmenting data items of an input data structure according to a plurality of levels of the first characteristic and, for each level, executing one or more transformation functions on the segmented data items to generate a respective intermediate data structure of the plurality of intermediate data structures. The input data structure for a first iteration may be the raw data and the input data structure for subsequent iterations may be an intermediate data structure generated by a preceding iteration. The method further includes combining the plurality of intermediate data structures to generate a cascaded data structure. A machine learning model can then be trained using the cascaded data structure.

In another aspect, a system is provided that comprises a memory storing instructions and one or more processors communicably coupled to the memory. The one or more processors are configured to execute the instructions to obtain raw data from sensors of one or more vehicles, where the raw data comprises a first characteristic. The one or more processors may also execute the instructions to iteratively generate a plurality of intermediate data structures by segmenting data items of an input data structure according to a plurality of levels of the first characteristic and, for each level, executing one or more transformation functions on the segmented data items to generate a respective intermediate data structure of the plurality of intermediate data structures. The input data structure for a first iteration may be the raw data and the input data structure for subsequent iterations may be an intermediate data structure generated by a preceding iteration. The one or more processors may also execute the instructions to combine the plurality of intermediate data structures to generate a cascaded data structure. The one or more processors may then execute the instructions to train a machine learning model using the cascaded data structure.

In another aspect, In another aspect, a system is provided that comprises a memory storing instructions and one or more processors communicably coupled to the memory. The one or more processors are configured to execute the instructions to set a plurality of hierarchical levels of resolution based on a characteristic and construct a cascaded data structure by iteratively segmenting data items of an input data structure according to the hierarchical levels of resolution and, for each level of the hierarchical levels of resolution, applying one or more aggregation functions to the segmented data items to generate one or more intermediate data structures that are combined to form the cascaded data structure. The one or more processors may also execute the instructions to apply at least one intermediate data structure from the cascaded data structure as training data to a machine learning model. An input data structure for a first level of the hierarchical levels of resolution may comprise raw sensor data collected by vehicles and an input data structure for subsequent levels of the hierarchical levels of resolution may comprise an intermediate data structure associated with a preceding level of the hierarchical levels of resolution.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example environment in which systems and methods for creating a cascaded data structure from raw sensor data equipped on vehicles can be implemented in accordance with examples of the present disclosure.

FIG. 2 depicts a system architecture for creating a cascaded data structure in accordance with examples of the present disclosure.

FIG. 3 illustrates an example input data structure comprising historical raw data provided as a table in accordance with an example of the present disclosure.

FIG. 4 illustrates an example intermediate data structure as a table in accordance with an example of the present disclosure.

FIG. 5 is a schematic representation of an example hybrid vehicle with which embodiments of the systems and methods disclosed herein may be implemented.

FIG. 6 illustrates an example architecture for generating raw sensor data in accordance with one embodiment of the systems and methods described herein.

FIG. 7 is an example computing component that may be used to implement various features of embodiments described in the present disclosure.

The figures are not exhaustive and do not limit the present disclosure to the precise form disclosed.

### DETAILED DESCRIPTION

Embodiments of the disclosed technology provide for generating cascaded data structures that can be used, for example, for training models for use in AI applications. The examples disclosed herein iteratively transform raw sensor data, collected by sensors on vehicles, according to hierarchical levels of resolution of the raw data to create output intermediate data structures, which can be combined to construct the cascaded data structure. Each output intermediate data structure can be used as an input intermediate data structure for a next iteration. Examples segment data items of a respective input intermediate data structure according to a level of resolution in the data items and execute a set of transformation functions on the segmented data items to generate respective output intermediate data structures. According to an example, an input intermediate data structure for a first iteration can comprise the initial, untransformed raw sensor data.

As alluded to above, AI may rely on the creation of models trained using training data. In an example, a model can be trained through an extract, transform, load (ETL) pipeline, which feeds training data to a model. Conventionally, training data can be created by selecting certain variables of interest (e.g., speed, fuel consumption, acceleration, etc.) in raw data and a level of resolution in the data. The level of resolution may be defined as a selected interval of time, geographic regions, certain vehicles of a fleet or an entire fleet, etc. The smaller the resolution desired translates to a smaller interval of the time interval, smaller geographic region, etc. and more numerous the number of data items. After training the model and checking the performance of the model, it may become apparent that model performance can be improved by training on a different collection of variables and/or a different level of resolution from the raw data.

Conventionally, adding a variable to the ETL pipeline can be expensive, particularly when working from historical data collected over a large fleet of vehicles. Modern vehicles can be equipped with multiple sensors, each of which can produce a vast amount of data. A Controller-Area-Network (CAN) bus, for example, allows a vehicle computer to communicate with hundreds of sensors at a relatively high temporal resolution (e.g. on the order of milliseconds). While some applications use CAN bus data online or in relatively short time intervals, many vehicular data processing tasks require processing data that spans a much longer time horizon. As the time horizon considered increases in magnitude, reliance on high temporal resolution can result in exceedingly numerous data items to be included in raw data. For example, a single vehicle can produce billions of data items in a year, a typical vehicle has a lifespan of about 10 years, and each year more than 10 million vehicles are sold in the USA alone. Thus, the number of data items produced collectively by these vehicles over the course of the vehicles' life can be tremendous. Running extensive computations on such datasets can be prohibitively expensive and is often preserved for targeted tasks which consider only a few preselected variables at a time.

In the case of exploratory model creation and research, targeted tasks are rarely an option because the models are not yet defined and the impact of the data on the models is unknown. In these cases, variables of importance to the model are generally not known in advance, nor are the type of transformations, or level of resolution known that will be of importance in a final model. Additionally, the model may generally require repeated training on different combinations of variables, types of transformations, and/or levels of resolution in order to produce an optimally performing model. As outlined above, repetitiously re-processing on tremendously large quantities of historical raw data needed to provide for this optimal model creation can be prohibitively expensive in terms of computation resources and time.

Embodiments disclosed herein provide for systems and methods that can reduce the number of computations and allow a broad range of research tasks to be addressed at a much lower cost in terms of computation resources and time. Examples disclosed herein obtain raw data that was collected by sensors equipped on one or more vehicles. The raw data comprises numerous data items representing sensed values for a plurality of different variables. Each data item may be associated with one or more characteristics of the data collection, such as, but not limited to, a temporal characteristic (e.g., a time at which a data item is acquired, such as a timestamp), a location characteristic (e.g., geographic coordinates of a location where the data item is acquired), a vehicle identification characteristic (e.g., type of vehicle, such as car, truck, SUV; make and model, VIN, etc.). Examples variables include, but are not limited to, vehicle speed, vehicle acceleration, fuel consumption, and any other variables that define a vehicle state. Examples disclosed herein generate a first output intermediate data structure by running a plurality of data transformation functions for each variable in the raw data at a first level of resolution. Then, using the first output intermediate data structure as an input, examples generate a second output intermediate data structuring by running the plurality of data transformation functions for each variable in the first output intermediate data structure at a second level of resolution. The process is repeated for a number of levels of resolution, where the output intermediate data structure generated for a preceding level of resolution is used as an input intermediate data structure for the next level of resolution. Accordingly, examples disclosed herein create output intermediate data structures, each of which to a distinct level of resolution. In some examples, each intermediate data structure may also correspond to a variable of the raw data. The output intermediate data structures can be combined to create a cascaded data structure.

The cascaded data structure can be provided for use in training ML models. For example, one or more of the output intermediate data structures can be extracted from the cascaded data structure and used as training data applied to a ML model. By computing transformations for a number of variables over a number of levels of transformation, different combinations of various variables, types of transformations, and/or levels of resolution can be readily available for training an optimal model. That is, for example, different combinations of training data can be pulled directly form the cascaded data structure, instead of requiring re-processing the raw data to obtain desired combinations. Accordingly, the embodiment disclosed herein can output a cascaded data structure that is task, model, and variable agnostic, because task, model and input variable need not be defined prior to creating the cascaded structure.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

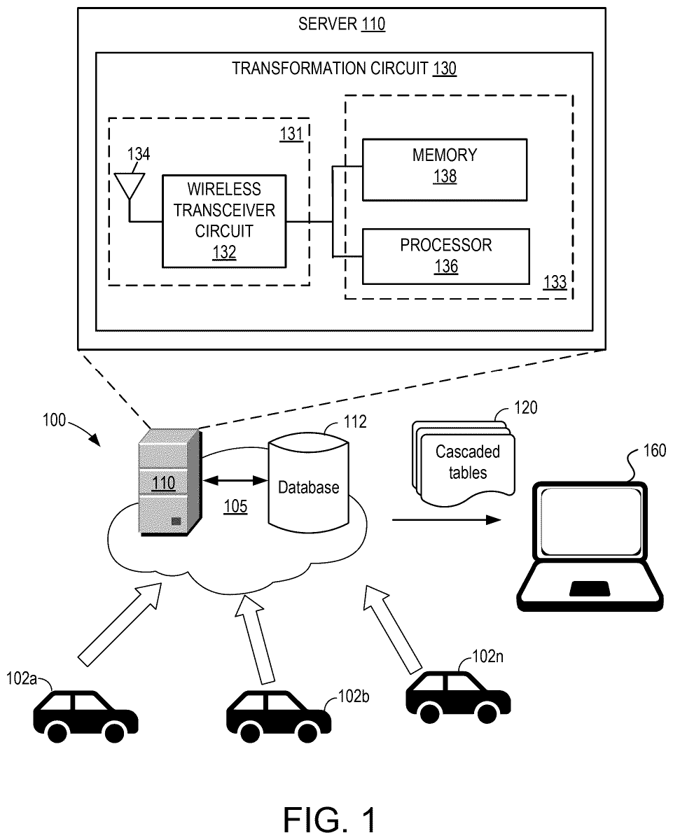

FIG. 1 illustrates an example environment 100 in which systems and methods for creating a cascaded data structure from raw sensor data equipped on vehicles can be implemented in accordance with examples of the present disclosure. FIG. 1 illustrates a plurality of vehicles 102a-102n (referred to collectively as vehicles 102 and in the singular as vehicle 102) communicatively coupled with a server 110 through wireless communications (e.g., V2X communications).

Vehicles 102 may each have one or more on-board sensors, e.g., vehicle operating condition sensors, environmental sensors, etc. On-board sensors can include one or more positioning systems such as a dead-reckoning system or a global navigation satellite system (GNSS), for example a global positioning system (GPS). The on-board sensors can also include Controller-Area-Network (CAN) sensors that output, for example, speed data, acceleration data, steering-angle data, fuel consumption, and other variables that define an operational state of each vehicle 102. An operational state (also referred to herein as an vehicle state) refers to a set of data items that represent a contemporaneous operation of a vehicle.

The on-board sensors collect data as raw sensor data (also referred to herein as raw data) while the vehicle is operated (e.g., travels on a roadway). Each sensor may collect raw data pertaining to a one or more variables for which the sensor is designed to sense. Example variables include, for example but not limited to, speed of the vehicle 102, acceleration of the vehicle 102, steering-angle of the vehicle 102, heading of the vehicle 102, fuel consumption of the vehicle 102, and other variables that can define a vehicle state of vehicle 102. The raw data collected by a given sensor may be obtained as time-series data, in which each data item is associated with a point in time and indexed in a time order.

The on-board sensors output the time-series data as data items, where each data item is defined as a value of a variable as sensed by the on-board sensor and a temporal characteristic indicative of a time at which the value for that variable was measured by the sensor. The temporal characteristic can be provided as a timestamp of the data item, which can be included as metadata.

Each data item can also be associated with a location characteristic indicative of a geographic location of the vehicle 102 at the point in time that the sensor generated a respective data item. The location characteristic can be provided as, for example, geographic coordinates of the vehicle 102, such as determined by GPS. Each data item can be tagged with a location characteristic (e.g., included in metadata).

The data items according to some examples can also be associated with a vehicle identification characteristic. That is, each data item can be associated with vehicle identification information, such as a type of vehicle, make and model of the vehicle, vehicle identification number (VIN), or the like. The vehicle identification information can be included as metadata associated with a respective data item.

Vehicles 102 may have vehicle-to-everything (V2X) communications capabilities, allowing each vehicle 102 to communicate with roadside equipment and/or infrastructure, as well as with network edge or cloud-based devices, such as the server 110 resident on network 105. In some examples, a vehicle 102 may receive data from roadside equipment or infrastructure over V2X communications. Additionally, a vehicle 102 itself may act as a network node or edge computing device and gather data from other vehicles. The data gathered by a vehicle 102, either through its own sensors, or other data sources, can be transmitted to the network edge device, such as server 110, and committed to a database 112 for subsequent use. For example, during operation, vehicles 102 may use on-board sensors to collect raw sensor data, as described above, which can be transmitted to the server 110. The server 110 may then store the raw sensor data in database 112 as historical raw data.

Historical raw data held in database 112 may include CAN bus data. CAN bus data can include records from numerous vehicles over a number of years (e.g., millions of vehicles over any number of years). The CAN bus is a vehicle bus standard designed to allow microcontrollers and devices (such as sensors and subsystems) to communicate with each other. A vehicle 102 may have numerous electronic control units (ECUs) for various subsystems, such as but not limited to, an engine control unit, as well as processors for Autonomous Driving, Advanced Driver Assistance System (ADAS); transmission; airbags; antilock braking/ABS; cruise control; electric power steering; audio systems; power windows; doors, mirror adjustment; battery and recharging systems for hybrid/electric cars; etc. The subsystems may need to control actuators or receive feedback from sensors, which can be satisfied using the CAN bus. This CAN bus data can be stored in a cloud instance, such as database 112, and as historical raw data that can be used training ML models for AI applications.

The server 110 may be configured generate a cascaded data structure 120 from the historical raw data, retrieved from the database 112, and output the cascaded data structure 120 to a frontend system 160. The cascaded data structure 120 may comprise a plurality of intermediate data structures combined into a single structure. For example, each intermediate data structures may correspond to a different level of resolution according to a characteristic (e.g., a temporal, spatial, and vehicle identification characteristics, as well as combinations thereof). In some examples, each intermediate data structure may also correspond to a different variable of the historical raw data transformed according to a set of transformation functions. In another example, an intermediate data structure for a given level of resolution may contain a number of different variables.

The cascaded data structure 120 can be used as training data for training a machine learning model of an AI system. For example, one or more of the intermediate data structures can be extracted directly from the cascaded data structure 120 as training data. By generating a plurality of intermediate data structures for different variables at different levels of resolution, the cascaded data structure 120 can mitigate a need to preform re-processing on the historical raw data by ensuring that the plurality of intermediate data structures are readily available as needed.

The server 110 can be connected to a frontend system 160 through which a user may access a user interface (UI) executed by the frontend system 160. The user, through the UI operating on the frontend system 160, may select one or more intermediate data structures from the cascaded data structure 120, for example, for use as training data. The frontend system 160 can then be executed to train a model of an AI system using the training data. In the case of, for example, exploratory model creation and research, different intermediate data structures can be accessed from the cascaded data structure 120 without a need to re-process the historical raw data, providing for optimizing models.

In some examples, control parameters can be input into the frontend system 160 via the UI for controlling the creation of the cascaded data structure 120. For example, a user may select one or more variables contained in the historical raw data to specify which variables are to be processed. However, the user need not select any specific variables, in which case processing can be performed on all variables contained in the historical raw data. In another example, the frontend system 160 may be executed to define a number of and a granularity of the levels of resolution for transforming the historical raw data. The levels of resolution may be based on temporal characteristics, spatial characteristics, vehicle identification characteristics, or combinations thereof. A user may select any number and granularity of resolution of the various levels. An example of levels of resolution based on temporal characteristics includes a trip-level that groups data items according to instances of continuous operation of a vehicle (e.g., a time between turning a vehicle 102 on to turning it off); day-level that groups data items according to the date (day, month, and year) at which the data items are captured by the on-board sensors; week-level that groups data items according to the week at which the data items were captured by the on-board sensors; month-level; year-level; and so on. An example of levels based on location characteristics includes a country-level; state-level, in the case of the United States; county-level; city-level; and so on. In another example, vehicle identification information, such as VIN, can be used to group data items according to make and/or models. In the examples above, the various levels of resolution can have a hierarchical order from highest resolution (smallest granularity) to lowest resolution (largest granularity).

In some examples, a user may select, via the UI, a set of transformation functions that can be applied to variables at to each level of resolution. In an illustrative example, the transformation functions may be implemented as aggregation functions that aggregate the historical raw data using a set of aggregation functions. Example aggregation functions include, but are not limited to, mean, median, summation, standard deviation, minimum vale, maximum value, first value, last value, etc. Examples herein can apply any set of aggregation functions desired to the historical raw data.

In an example implementation, as shown in FIG. 1, server 110 can include a transformation circuit 130, which comprises a communication circuit 131, and a decision circuit 133 (including a processor 136 and memory 138 in this example). Transformation circuit 130 can be used to obtain historical raw data from database 112 and generate the cascaded data structure 120. Components of transformation circuit 130 are illustrated as communicating with each other via a data bus, although other communication interfaces can be included.

Processor 136 can include one or more GPUs, CPUs, microprocessors, or any other suitable processing system. Processor 136 may include a single core or multicore processors. The memory 138 may include one or more various forms of memory or data storage (e.g., flash, RAM, etc.) that may be used to store instructions and variables for processor 136 as well as any other suitable information, such as, one or more of the following elements: control parameters, intermediate data structures, and the like. Memory 138 can be made up of one or more modules of one or more different types of memory, and may be configured to store data and other information as well as operational instructions that may be used by the processor 136 for generating cascaded data structure 120.

In the example implementation of FIG. 1, memory 138 comprises modules that can be executed for creating a cascaded data structure in accordance with the examples disclosed herein, such as described above. Modules as used herein may refer to instructions provided as executable software codes that can be executed by processor 136 for executing operations defined by the modules. These and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

Although the example of FIG. 1 is illustrated using processor and memory circuitry, as described below with reference to circuits disclosed herein, decision circuit 133 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a transformation circuit 130.

Communication circuit 131 includes a wireless transceiver circuit 132 with an associated antenna 134. Communication circuit 114 can provide for vehicle-to-everything (V2X), allowing transformation circuit 130 to communicate vehicles 102 via network 105. Wireless transceiver circuit 132 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 134 is coupled to wireless transceiver circuit 132 and is used by wireless transceiver circuit 132 to transmit radio signals wirelessly to wireless equipment with which it is connected and to receive radio signals as well. These RF signals can include information of almost any sort that is sent or received by transformation circuit 130 to/from other entities such as frontend system 160.

Network 105 may be a conventional type of network, wired or wireless, and may have numerous different configurations including a star configuration, token ring configuration, or other configurations. Furthermore, the network 105 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 105 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VOLTE, 5G-V2X or any other mobile data network or combination of mobile data networks. Further, the network 105 may include one or more IEEE 802.11 wireless networks.

In some embodiments, the network 105 includes a V2X network (e.g., a V2X wireless network). The V2X network is a communication network that enables entities such as elements of the operating environment to wirelessly communicate with one another via one or more of the following: Wi-Fi; cellular communication including 3G, 4G, LTE, 5G, etc.; Dedicated Short Range Communication (DSRC); millimeter wave communication; etc. As described herein, examples of V2X communications include, but are not limited to, one or more of the following: Dedicated Short Range Communication (DSRC) (including Basic Safety Messages (BSMs) and Personal Safety Messages (PSMs), among other types of DSRC communication); Long-Term Evolution (LTE); millimeter wave (mmWave) communication; 3G; 4G; 5G; LTE-V2X; 5G-V2X; LTE-Vehicle-to-Vehicle (LTE-V2V); LTE-Device-to-Device (LTE-D2D); Voice over LTE (VOLTE); etc. In some examples, the V2X communications can include V2V communications, Vehicle-to-Infrastructure (V2I) communications, Vehicle-to-Network (V2N) communications or any combination thereof.

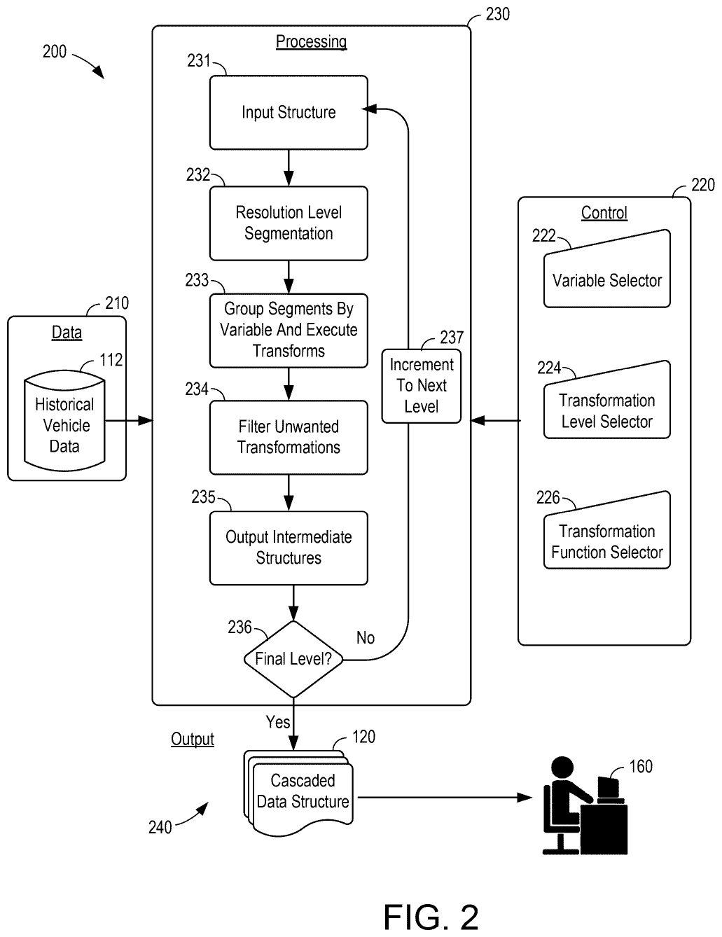

FIG. 2 depicts a system architecture 200 for creating a cascaded data structure in accordance with examples of the present disclosure. Architecture 200 may be implemented by processor 136, for example, architecture 200 may be stored as modules in memory 138, that when executed by processor 136, transforms raw data into a cascaded data structure that can be output to a frontend system 160, as described above. In the example of FIG. 2, architecture 200 comprises a data input module 210, a control module 220, a processing module 230, and an output module 240.

The data input module 210 may be executed to obtain raw historical data from database 112 or other storage device. As described above, the historical raw data may be received from vehicles via V2X communications and stored in database 112. As described above, the historical raw data may include raw sensor data, such as CAN bus data. The historical raw data can be accessed from the database 112 and fed to the processing module 230 as an input. The historical raw data may include one or more variables collected by sensors on vehicles, as described above. Example variables include, for example but not limited to, speed, acceleration, steering-angle, heading, fuel consumption, and other variables that can define a vehicle state of a vehicle (e.g., vehicle 102). The historic raw data can be provided as time-series data, in which each data item is associated with a point in time and indexed in a time order.

Control module 220 may be executed to define various control parameters for controlling the processing module 230. The control parameters may be default parameters and/or user defined parameters (e.g., received via frontend system 160), as described above. The control module 220 can receive inputs that select control parameters for defining a plurality of levels of resolution having a hierarchical order according to one or more characteristics of the historical raw data; one or more variables of the historical raw data; and a set of transformation functions. In some examples, control module 220 may receive inputs from a frontend system 160, such as a user input selecting certain parameters. The control module 220 may then set the control parameters in processing module 230 to control execution of operations performed by processing module 230.

The control module 220 may comprise a variable selector module 222 that can be configured to receive inputs selecting a subset of variables contained in the historical raw data. The variable selector module 222 can then specify (e.g., designate) those selected variables of the historical raw data to be processed by the processing module 230. Alternatively, all variables contained in the historical raw data may be designated as a default parameter.

The control module 220 may comprise a transformation selector module 224 that can be configured to receive one or more inputs selecting a plurality of levels of resolution. The transformation selector module 224 may also receive an input selecting one or more characteristics of the historical raw data. The transformation selector module 224 may then set a number of levels arranged in an order of decreasing resolution of the one or more characteristics. As an illustrative example, the transformation selector module 224 set a number of levels of resolution according to temporal characteristics (e.g., a various intervals of time), and define an order of increasing intervals of the temporal characteristics (e.g., a first level corresponds to the smallest interval of time and each subsequent level corresponds to an increasingly larger interval of time). As another example, transformation selector module 224 may set levels of resolution for geographic characteristics, with each level corresponding to an increasing larger geographic region. In yet another example, transformation selector module 224 may set levels of resolution according to both temporal and spatial characteristics. In one example, each level may correspond to an increasing larger interval of time, with sub-levels between each level and having an order of increasing larger geographic regions. As another example, each level may correspond to an increasing larger geographic region, with sub-levels between each level and having an order of increasing larger intervals of time.

While certain examples are provided above, one skilled in the art will appreciate that the present disclosure is not limited to only the above recited examples. Other configurations of characteristics can be implemented, such as levels and/or sub-levels based on vehicle identification characteristics.

The control module 220 may comprise a transformation function selector module 226 that can be configured to receive inputs selecting a set of transformation functions to be executed by processing module 230. As described above, the transformation functions may be implemented as aggregation functions.

Processing module 230 may be executed to create cascaded data structure 120 by iteratively generating a plurality of intermediate data structures based on the control parameters set by control module 220. For example, processing module 230 performs operations 231-236 in an iterative loop for the number of levels of resolution as defined in the control parameters set by the control module 220. For example, processing module 230 may iteratively execute each of the operations 231-236 for each level of resolution, set by the transformation level selector module 224, according to the hierarchical order (e.g., the smallest level or resolution at a first iteration to largest level of resolution at the last iteration) to generate the plurality of intermediate data structures. The processing module 230 can output each intermediate data structure to a memory (e.g., memory 138 or database 112), each associated with a given level of resolution. The output module 240 can then compile the plurality of intermediate data structures into a single data structure, thereby generating the cascaded data structure 120.

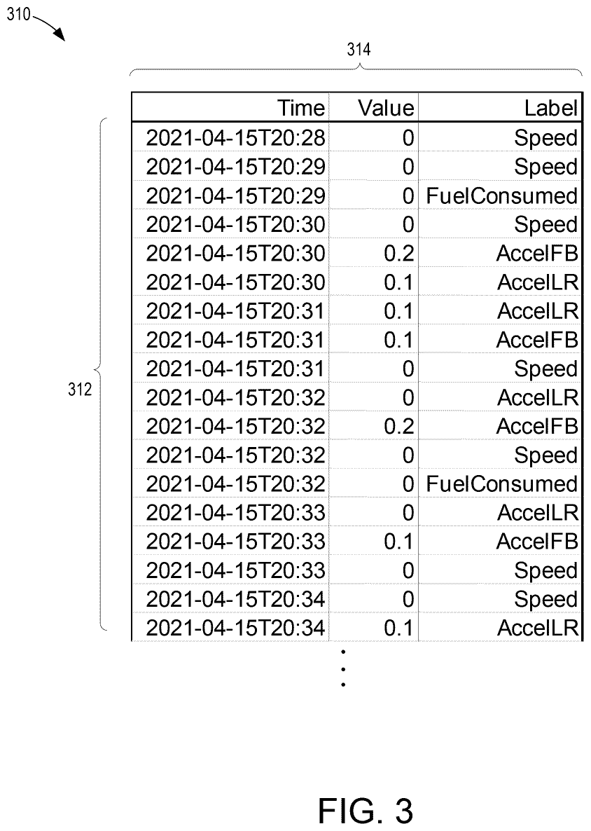

The iterative loop executed by processing module 230 begins at operation 231, where an input data structure is received. In the case of a first (e.g., initial) iteration, the historical raw data can be provided to the processing module 230 as an input data structure, an example of which is shown in FIG. 3. Then, for each subsequent iteration, the input data structure may be one or more intermediate data structures output by a preceding iteration (e.g., from operation 236). In a case where a subset of the variables of the historical raw data are set by the variable selector module 222, the unselected variables may be filtered out or otherwise operation 231 may retrieve only the variables of interest.

At operation 232, the input data structured can be segmented according to a level of resolution for the current iteration. For example, operation 232 may segment data items of the input data structure into groups of data items according to the level of resolution of a characteristic set for the current iteration. Said another way, operation 232 may create segments of data items by grouping data items according to the level of resolution for current iteration. As described above, the level of resolution may be with respect to a temporal characteristics, spatial characteristics, vehicle identification characteristics and/or any combination thereof. As an example, where a temporal characteristic is selected, at a first level of resolution the data items can be segmented into groups defined by a smallest interval of time. For the next iteration, data items can be segmented into groups defined by the next interval of time, and so on. Similar segmentation can be performed for spatial characteristics, as well as combinations of characteristics.

At operation 233, the segmented data items can be grouped according to variables and the set of transformation functions can be executed on the resulting variable-wise groups of data items. For example, operation 233 may receive level-wise groupings of data items segmented according to the level of resolution for a current iteration from operation 232. Operation 233 may then further segment the level-wise groupings on a variable-basis to produce variable-wise groups, and execute each transformation function, as defined by the transformation function selector module 226, on each variable-wise group of data items simultaneously. Thus, each group of data items can be transformed into a single data item having a value for each transformation function that is representative of the group. In examples, transformation functions can be provided as aggregation functions, each of which aggregate data items of a given grouping to output a single value for that grouping for each aggregation function.

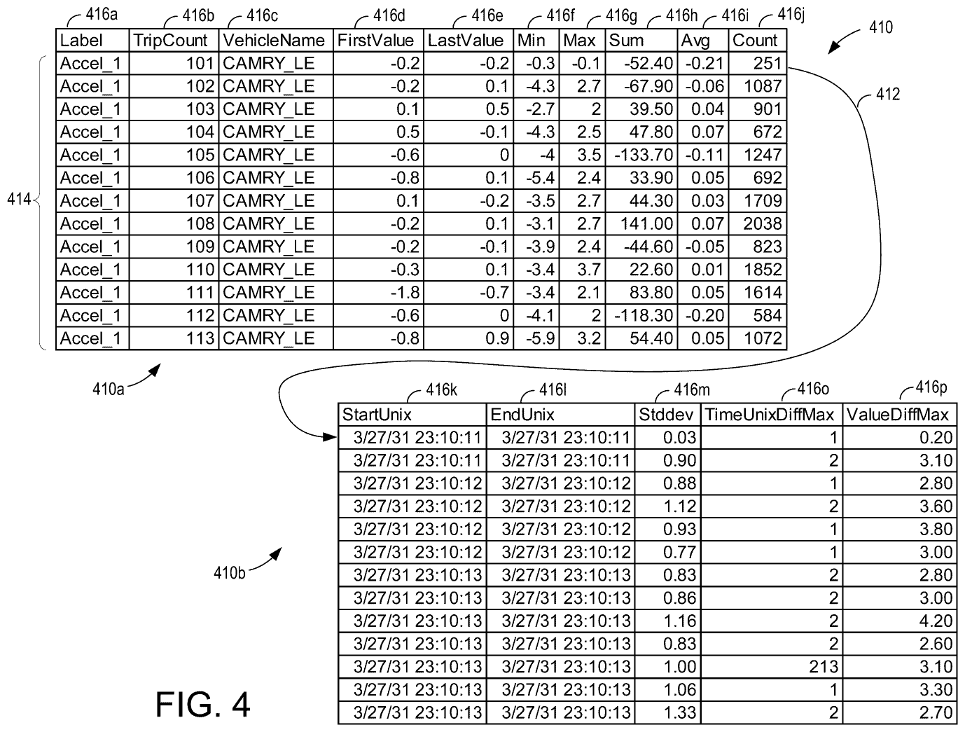

At operation 235, one or more intermediate data structures can be constructed from the transformed data items obtained at operation 233. For example, operation 235 may receive each transformed data item for a given variable and insert the transformed data items for the given variable into an intermediate data structure for that variable. In an example, each data item may be labeled with a variable label and comprise a value for each transformation function that is executed. Each intermediate data structure can be associated with the level of resolution of the current iteration and may contain a number of data items. Each data item may represent a level-wise group (e.g., a segment of the data items of the input data structure grouped according to the current level of resolution). In some cases, each intermediate data structure may correspond to a single variable, in which case operation 235 may construct a number of intermediate data structures based on the number of variables that are processed. In another example, operation 235 may generate a single intermediate data structure that contains all processed variables. Operation 235 may output the one or more intermediate data structures to memory 138 and/or database 112. An example of an intermediate data structure is provided in FIG. 4.

Optionally, operation 234 may executed between operations 233 and 235 to filter out unwanted transformations that may be deemed unnecessary according to the control parameters. As a result, the intermediate data structures created at operation 233 may include only the desired aggregation functions. This operation may be included, opposed to simply defining fewer transformation functions at the outset, because running each transformation function simultaneously can provide a computational advantage since the transformations are part of set executed by operation 233. It may be desirable to remove certain transformations for certain levels of resolution, while deeming those certain transformations necessary at other levels of resolution. For example, a summation of all values may not be as informative for a longer time interval (e.g., lower resolution) as it is for a shorter time intervals.

As described above, the one or more intermediate data structures created at operation 235 can be used as an input data structure for a next iteration of the loop executed by processing module 230. For example, at operation 236, a determination is made whether the level of resolution for the current iteration is the final level as set by the transformation level selector module 224. If the determination at operation 236 is negative, operation 237 is performed to increment the level of resolution to the next level in the hierarchical order and repeat operations 231-236 using the intermediate data structure generated at operation 235 as the input for operation 231. In an example, a counter may be used, set to 1 at the first iteration (e.g., prior to operation 231), and then incremented until the counter matches the number of levels as defined by the transformation level selector module 224.

If the determination at operation 236 is affirmative, the one or more intermediate data structures generated for each iteration are compiled into a single data structure, thereby creating the cascaded data structure 120. The cascaded data structure 120 can be stored in memory 138 and/or database 112 for access by the frontend system 160. The cascaded data structure 120 may be a sequence of cascading intermediate data structures, each of which summarizes the historical raw data at the different levels of resolution as defined by the transformation level selector module 224. The intermediate data structures may satisfy a majority of input requirements for the exploratory model creation and eliminate a need to access and re-process the raw data if additional variables or resolutions are needed.

FIG. 3 illustrates an example input data structure comprising historical raw data provided as a table 310 in accordance with an example of the present disclosure. The table 310 comprises a number of rows 312 and columns 314. Each row represents a data item of raw data with the values and characteristics of for that data item entered into the columns. The data items may be obtained from sensor on-board a vehicle, such as vehicle 102. The data items may be obtained from any number of vehicles over any time horizon. While FIG. 3 illustrates a certain number of data items, this is for illustrative purposes only. The table 310 may include any number of data items, and most likely would consist of exceedingly numerous amount of data items in a real-world application.

FIG. 4 illustrates an example intermediate data structure as a table 410 in accordance with an example of the present disclosure. The table 410 may be generated at operation 236 as described above in connection with FIG. 2. The table 410 is shown as sub-tables 410a and 410b for illustrative purposes only. Each row of table 410b is a continuation of a corresponding row from table 410a, an example of which is shown via arrow 412.

Table 410 depicts results of executing a set of transformations functions on a plurality of groupings of a single variable (e.g., vehicle speed in this example) for a particular level of resolution from historical raw data. Table 410 comprises a plurality of rows 414, each corresponding to a transformed data item. That is, each transformed data item corresponds to a grouping or segment of the raw data, segmented according to the particular level of resolution associated with the intermediate data structure. In this case, the historical raw data was segmented according to trip-level. Table 410 also includes a plurality of columns 416a-416p. Columns 416a includes a label of the variable of interest (e.g., acceleration in this example). Column 416b includes a segmentation count, shown as a trip count (e.g., an index for a particular trip) in this case and column 416c provides a vehicle identification characteristic (e.g., a vehicle name in this example). Columns 416d-416p include values resulting from the set of transformation functions (e.g., first value, last value, minimum, maximum, sum, average, count, start unix time, end unix time, standard deviation, unix time difference, value different maximum). executed on each grouping according to this example.

While FIG. 4 illustrates a certain number of transformed data items, this is for illustrative purposes only. The table 410 may include any number of transformed data items based on the number of data items in the raw data and the desired resolution.

In various examples, table 410 may be used as an input intermediate data structure for a next iteration. In this case, the next iteration may segment the transformed data items of table 410 according to a lower resolution of a desired characteristic (e.g., larger interval of the temporal characteristic in this case). The transformation functions can then be applied to the groupings as described above to ultimately provide a next intermediate data structure.

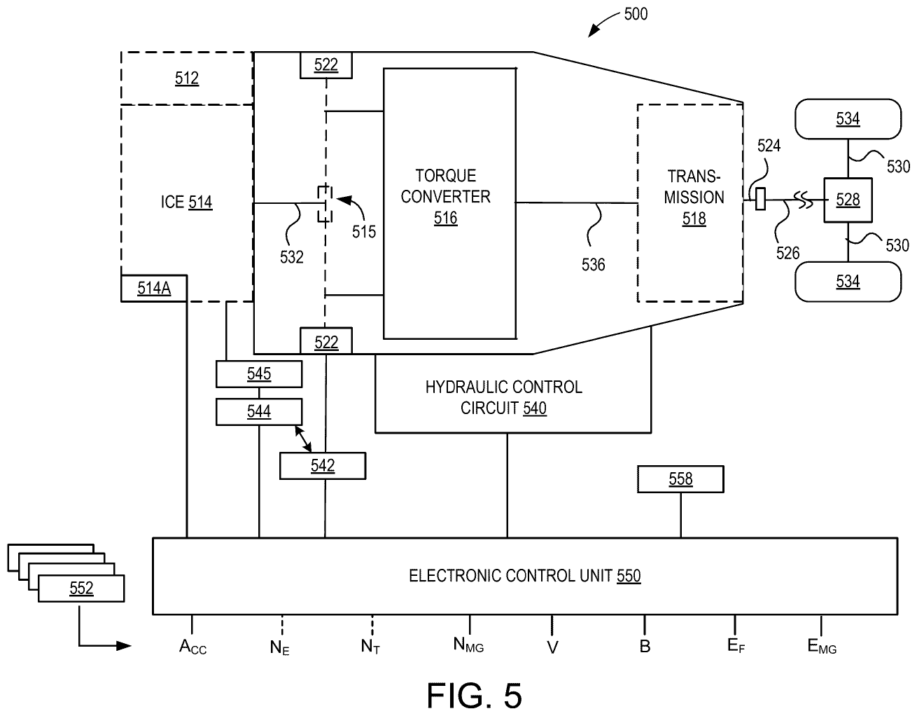

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 5, which may be an example of vehicle 102 of FIG. 1. Although the example described with reference to FIG. 5 is a hybrid type of vehicle, the systems and methods for creating cascaded data structures can be implemented in other types of vehicle including gasoline-or diesel-powered vehicles, fuel-cell vehicles, electric vehicles, or other vehicles.

FIG. 5 illustrates a drive system of an example vehicle 500 that may include an internal combustion engine 514 and one or more electric motors 522 (which may also serve as generators) as sources of motive power. Driving force generated by the internal combustion engine 514 and motors 522 can be transmitted to one or more wheels 534 via a torque converter 516, a transmission 518, a differential gear device 528, and a pair of axles 530.

As an HEV, vehicle 500 may be driven/powered with either or both of engine 514 and the motor(s) 522 as the drive source for travel. For example, a first travel mode may be an engine-only travel mode that only uses internal combustion engine 514 as the source of motive power. A second travel mode may be an EV travel mode that only uses the motor(s) 522 as the source of motive power. A third travel mode may be an HEV travel mode that uses engine 514 and the motor(s) 522 as the sources of motive power. In the engine-only and HEV travel modes, vehicle 500 relies on the motive force generated at least by internal combustion engine 514, and a clutch 515 may be included to engage engine 514. In the EV travel mode, vehicle 500 is powered by the motive force generated by motor 522 while engine 514 may be stopped and clutch 515 disengaged.

Engine 514 can be an internal combustion engine such as a gasoline, diesel or similarly powered engine in which fuel is injected into and combusted in a combustion chamber. A cooling system 512 can be provided to cool the engine 514 such as, for example, by removing excess heat from engine 514. For example, cooling system 512 can be implemented to include a radiator, a water pump and a series of cooling channels. In operation, the water pump circulates coolant through the engine 514 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 514. In other applications, either or both the water pump and the fan may be operated by electric current such as from battery 544.

An output control circuit 514A may be provided to control drive (output torque) of engine 514. Output control circuit 514A may include a throttle actuator to control an electronic throttle valve that controls fuel injection, an ignition device that controls ignition timing, and the like. Output control circuit 514A may execute output control of engine 514 according to a command control signal(s) supplied from an electronic control unit 550, described below. Such output control can include, for example, throttle control, fuel injection control, and ignition timing control.

Motor 522 can also be used to provide motive power in vehicle 500 and is powered electrically via a battery 544. Battery 544 may be implemented as one or more batteries or other power storage devices including, for example, lead-acid batteries, nickel-metal hydride batteries, lithium ion batteries, capacitive storage devices, and so on. Battery 544 may be charged by a battery charger 545 that receives energy from internal combustion engine 514. For example, an alternator or generator may be coupled directly or indirectly to a drive shaft of internal combustion engine 514 to generate an electrical current as a result of the operation of internal combustion engine 514. A clutch can be included to engage/disengage the battery charger 545. Battery 544 may also be charged by motor 522 such as, for example, by regenerative braking or by coasting during which time motor 522 operate as generator.

Motor 522 can be powered by battery 544 to generate a motive force to move the vehicle and adjust vehicle speed. Motor 522 can also function as a generator to generate electrical power such as, for example, when coasting or braking. Battery 544 may also be used to power other electrical or electronic systems in the vehicle. Motor 522 may be connected to battery 544 via an inverter 542. Battery 544 can include, for example, one or more batteries, capacitive storage units, or other storage reservoirs suitable for storing electrical energy that can be used to power motor 522. When battery 544 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 550 (described below) may be included and may control the electric drive components of the vehicle as well as other vehicle components. For example, electronic control unit 550 may control inverter 542, adjust driving current supplied to motor 522, and adjust the current received from motor 522 during regenerative coasting and breaking. As a more particular example, output torque of the motor 522 can be increased or decreased by electronic control unit 550 through the inverter 542.

A torque converter 516 can be included to control the application of power from engine 514 and motor 522 to transmission 518. Torque converter 516 can include a viscous fluid coupling that transfers rotational power from the motive power source to the driveshaft via the transmission. Torque converter 516 can include a conventional torque converter or a lockup torque converter. In other embodiments, a mechanical clutch can be used in place of torque converter 516.

Clutch 515 can be included to engage and disengage engine 514 from the drivetrain of the vehicle. In the illustrated example, a crankshaft 532, which is an output member of engine 514, may be selectively coupled to the motor 522 and torque converter 516 via clutch 515. Clutch 515 can be implemented as, for example, a multiple disc type hydraulic frictional engagement device whose engagement is controlled by an actuator such as a hydraulic actuator. Clutch 515 may be controlled such that its engagement state is complete engagement, slip engagement, and complete disengagement complete disengagement, depending on the pressure applied to the clutch. For example, a torque capacity of clutch 515 may be controlled according to the hydraulic pressure supplied from a hydraulic control circuit (not illustrated). When clutch 515 is engaged, power transmission is provided in the power transmission path between the crankshaft 532 and torque converter 516. On the other hand, when clutch 515 is disengaged, motive power from engine 514 is not delivered to the torque converter 516. In a slip engagement state, clutch 515 is engaged, and motive power is provided to torque converter 516 according to a torque capacity (transmission torque) of the clutch 515.

As alluded to above, vehicle 500 may include an electronic control unit 550. Electronic control unit 550 may include circuitry to control various aspects of the vehicle operation. Electronic control unit 550 may include, for example, a microcomputer that includes a one or more processing units (e.g., microprocessors), memory storage (e.g., RAM, ROM, etc.), and I/O devices. The processing units of electronic control unit 550, execute instructions stored in memory to control one or more electrical systems or subsystems 558 in the vehicle. Electronic control unit 550 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 5, electronic control unit 550 receives information from a plurality of sensors included in vehicle 500. For example, electronic control unit 550 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 514 (engine RPM), a rotational speed, NMG, of the motor 522 (motor rotational speed), and vehicle speed, NV. These may also include torque converter 516 output, NT (e.g., output amps indicative of motor output), brake operation amount/pressure, B, battery SOC (i.e., the charged amount for battery 544 detected by an SOC sensor). Accordingly, vehicle 500 can include a plurality of sensors 552 that can be used to detect various conditions internal or external to the vehicle and provide sensed conditions to engine control unit 550 (which, again, may be implemented as one or a plurality of individual control circuits). In one embodiment, sensors 552 may be included to detect one or more conditions directly or indirectly such as, for example, fuel efficiency, EF, motor efficiency, EMG, hybrid (internal combustion engine 514+MG 522) efficiency, acceleration, ACC, etc. In various examples, the vehicle 500 may receive CAN sensors that can provide information to electronic control unit 550, such as but not limited to, speed data, acceleration data, steering-angle data, fuel consumption, and other variables that define an operational state of each vehicle 500.

In some embodiments, one or more of the sensors 552 may include their own processing capability to compute the results for additional information that can be provided to electronic control unit 550. In other embodiments, one or more sensors may be data-gathering-only sensors that provide only raw data to electronic control unit 550. In further embodiments, hybrid sensors may be included that provide a combination of raw data and processed data to electronic control unit 550. Sensors 552 may provide an analog output or a digital output

Sensors 552 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect objects in an environment surrounding vehicle 500, for example, traffic signs indicating a current speed limit, road curvature, obstacles, surrounding vehicles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 5 is provided for illustration purposes only as one example of vehicle systems with which embodiments of the disclosed technology may be implemented. One of ordinary skill in the art reading this description will understand how the disclosed embodiments can be implemented with this and other vehicle platforms.

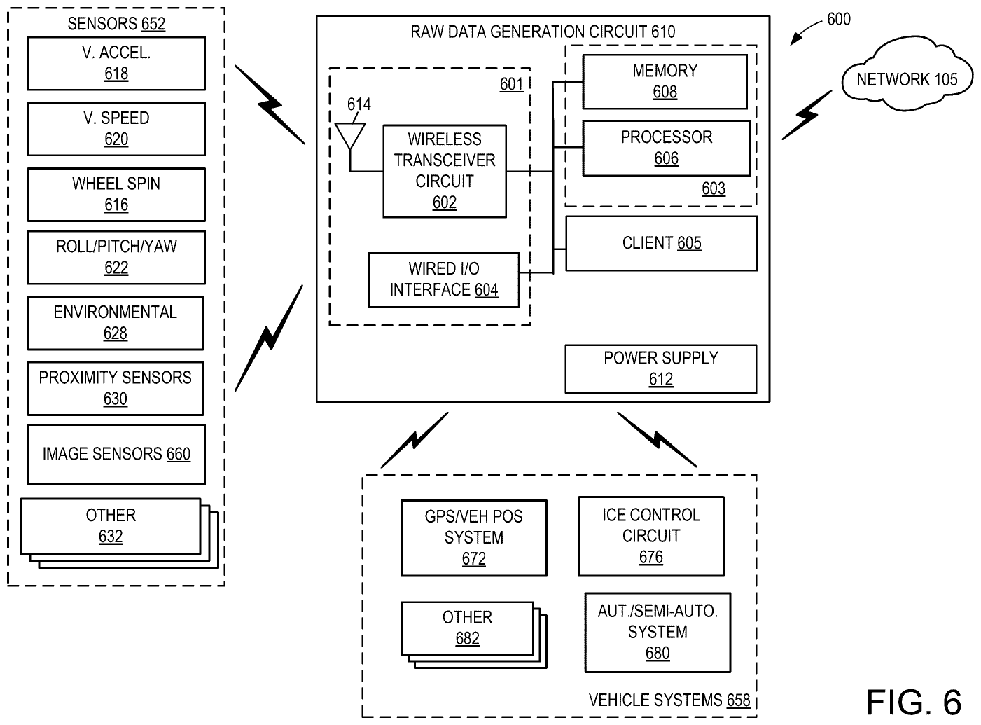

FIG. 6 illustrates an example architecture for generating raw sensor data in accordance with one embodiment of the systems and methods described herein. Referring now to FIG. 6, in this example, raw data generation system 600 includes a raw data generation circuit 610, a plurality of sensors 652 and a plurality of vehicle systems 658. Sensors 652 (such as sensors 552 described in connection with FIG. 5) and vehicle systems 658 (such as subsystems 558 described in connection with FIG. 5) can communicate with raw data generation circuit 610 via a wired or wireless communication interface. Although sensors 652 and vehicle systems 658 are depicted as communicating with raw data generation circuit 610, they can also communicate with each other as well as with other vehicle systems. raw data generation circuit 610 can be implemented as an ECU or as part of an ECU such as, for example electronic control unit 550. In other embodiments, raw data generation circuit 610 can be implemented independently of the ECU.

Raw data generation circuit 610 in this example includes a communication circuit 601, a decision circuit 603 (including a processor 606 and memory 608 in this example) and a power supply 612. Components of raw data generation circuit 610 are illustrated as communicating with each other via a data bus, although other communication in interfaces can be included. Raw data generation circuit 610 in this example also includes client 605 that can be operated to connect to an edge server (e.g., server 110 of FIG. 1) of a network 105 to contribute raw vehicle data to database 112.

Processor 606 can include one or more GPUs, CPUs, microprocessors, or any other suitable processing system. Processor 606 may include a single core or multicore processors. The memory 608 may include one or more various forms of memory or data storage (e.g., flash, RAM, etc.) that may be used to store instructions and variables for processor 606 as well as any other suitable information, such as, one or more of the following elements: position data; vehicle speed data; acceleration data, steering- angle data, and fuel consumption, along with other data as needed. Memory 608 can be made up of one or more modules of one or more different types of memory, and may be configured to store data and other information as well as operational instructions that may be used by the processor 606 to raw data generation circuit 610.

Although the example of FIG. 6 is illustrated using processor and memory circuitry, as described below with reference to circuits disclosed herein, decision circuit 603 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a raw data generation circuit 610.

Communication circuit 601 includes either or both a wireless transceiver circuit 602 with an associated antenna 614 and a wired I/O interface 604 with an associated hardwired data port (not illustrated). Communication circuit 601 can provide for vehicle-to-everything (V2X) and/or vehicle-to-vehicle (V2V) communications capabilities, allowing raw data generation circuit 610 to communicate with edge devices, network cloud servers and cloud-based databases, and/or other vehicles via network 105. For example, V2X communication capabilities allows raw data generation circuit 610 to communicate with edge/cloud servers, such as server 110 of FIG. 1. Raw data generation circuit 610 may also communicate with other connected vehicles over vehicle-to-vehicle (V2V) communications.

As this example illustrates, communications with raw data generation circuit 610 can include either or both wired and wireless communications circuits 601. Wireless transceiver circuit 602 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 614 is coupled to wireless transceiver circuit 602 and is used by wireless transceiver circuit 602 to transmit radio signals wirelessly to wireless equipment with which it is connected and to receive radio signals as well. These RF signals can include information of almost any sort that is sent or received by raw data generation circuit 610 to/from other entities such as sensors 652 and vehicle systems 658.

Wired I/O interface 604 can include a transmitter and a receiver (not shown) for hardwired communications with other devices. For example, wired I/O interface 604 can provide a hardwired interface to other components, including sensors 652 and vehicle systems 658. Wired I/O interface 604 can communicate with other devices using Ethernet or any of a number of other wired communication protocols whether standardized, proprietary, open, point-to-point, networked or otherwise.

Power supply 612 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 652 can include, for example, sensors 552 such as those described above with reference to the example of FIG. 5. Sensors 652 can include additional sensors that may or may not otherwise be included on a standard vehicle with which the raw data generation system 600 is implemented. Sensors 652 may also be implemented as CAN bus sensors that generate CAN bus data. In the illustrated example, sensors 652 include vehicle acceleration sensors 618, vehicle speed sensors 620, wheelspin sensors 616 (e.g., one for each wheel), accelerometers such as a 6-axis accelerometer 622 to detect roll, pitch and yaw of the vehicle, environmental sensors 628 (e.g., to detect salinity or other environmental conditions), and proximity sensor 630 (e.g., sonar, radar, lidar or other vehicle proximity sensors). Additional sensors 632, such as fuel consumption sensors, can also be included as may be appropriate for a given implementation of raw data generation system 600.

System 600 may be equipped with one or more image sensors 660. These may include front facing image sensors, side facing image sensors, and/or rear facing image sensors. Image sensors may capture information which may be used in detecting not only vehicle conditions but also detecting conditions external to the vehicle as well. Image sensors that might be used to detect external conditions can include, for example, cameras or other image sensors configured to capture data in the form of sequential image frames forming a video in the visible spectrum, near infra-red (IR) spectrum, IR spectrum, ultra violet spectrum, etc.

Vehicle systems 658, for example, systems and subsystems 558 described above with reference to the example of FIG. 5, can include any of a number of different vehicle components or subsystems used to control or monitor various aspects of the vehicle and its performance. In this example, the vehicle systems 658 includes a vehicle positioning system 672 (e.g., a global positioning system (GPS) or the like); engine control circuits 676 to control the operation of engine (e.g. internal combustion engine 514 and/or motors 522);, and other vehicle systems 682 (e.g., Advanced Driver-Assistance Systems (ADAS), autonomous or semi-autonomous driving systems 680, such as forward/rear collision detection and warning systems, pedestrian detection systems, autonomous or semi-autonomous driving systems, and the like).

During operation, communication circuit 601 can be used to transmit and receive information between raw data generation circuit 610 and sensors 652, and raw data generation circuit 610 and vehicle systems 658. Also, sensors 652 may communicate with vehicle systems 658 directly or indirectly (e.g., via communication circuit 601 or otherwise). Furthermore, communication circuit 601 can be used to transmit information, obtained by sensors 652 and/or systems 658 to edge/cloud servers via network 105.

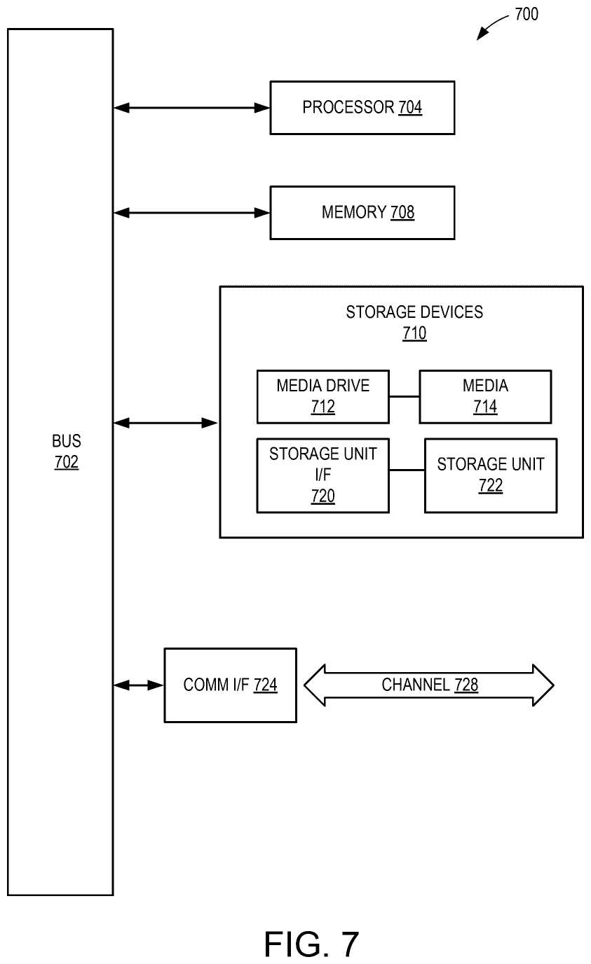

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 7. Various embodiments are described in terms of this example-computing component 700. After reading this description, it will become apparent to a person skilled in the relevant art how to implement the application using other computing components or architectures.

Referring now to FIG. 7, computing component 700 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 700 might also represent computing capabilities embedded within or otherwise available to a given device. For example, a computing component might be found in other electronic devices such as, for example, portable computing devices, and other electronic devices that might include some form of processing capability.

Computing component 700 might include, for example, one or more processors, controllers, control components, or other processing devices. This can include a processor, and/or any one or more of the components making up server 110, vehicles 102, and/or frontend system 160 of FIG. 1, as well as raw data generation system 300 of FIG. 3. Processor 704 might be implemented using a general-purpose or special-purpose processing engine such as, for example, a microprocessor, controller, or other control logic. Processor 704 may be connected to a bus 702. However, any communication medium can be used to facilitate interaction with other components of computing component 700 or to communicate externally.

Computing component 700 might also include one or more memory components, simply referred to herein as main memory 708. For example, random access memory (RAM) or other dynamic memory, might be used for storing information and instructions to be executed by processor 704. Main memory 708 may instructions for executing one or more the modules described in connection with FIG. 2. Main memory 708 might also be used for storing temporary variables or other intermediate information during execution of instructions to be executed by processor 704. Computing component 700 might likewise include a read only memory (“ROM”) or other static storage device coupled to bus 702 for storing static information and instructions for processor 704.

The computing component 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a solid-state drive, a magnetic tape drive, an optical drive, a compact disc (CD) or digital video disc (DVD) drive (R or RW), or other removable or fixed media drive might be provided. Storage media 714 might include, for example, a hard disk, an integrated circuit assembly, magnetic tape, cartridge, optical disk, a CD or DVD. Storage media 714 may be any other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing component 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory component) and memory slot. Other examples may include a PCMCIA slot and card, and other fixed or removable storage units 722 and interfaces 720 that allow software and data to be transferred from storage unit 722 to computing component 700.

Computing component 700 might also include a communications interface 724. Communications interface 724 might be used to allow software and data to be transferred between computing component 700 and external devices. Examples of communications interface 724 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 724 may be carried on signals, which can be electronic, electromagnetic (which includes optical) or other signals capable of being exchanged by a given communications interface 724. These signals might be provided to communications interface 724 via a channel 728. Channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 708, storage unit 722, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 700 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
obtaining raw data from sensors of one or more vehicles, wherein the raw data comprises a first characteristic;
iteratively generating a plurality of intermediate data structures by segmenting data items of an input data structure according to a plurality of levels of the first characteristic and, for each level, executing one or more transformation functions on the segmented data items to generate a respective intermediate data structure of the plurality of intermediate data structures, wherein the input data structure for a first iteration comprises the raw data and the input data structure for subsequent iterations is an intermediate data structure generated by a preceding iteration;
combining the plurality of intermediate data structures to generate a cascaded data structure; and
train a machine learning model using the cascaded data structure.

2. The method of claim 1, wherein the first characteristic comprises at least one of a temporal characteristic and a spatial characteristic.

3. The method of claim 1, wherein each intermediate data structure of the plurality of intermediate data structures corresponds to a level of the plurality of levels.

4. The method of claim 3, wherein each intermediate data structure of the plurality of intermediate data structures corresponds to a variable contained in the raw data.

5. The method of claim 1, wherein the plurality of levels are arranged in an hierarchical order, wherein a level of the plurality of levels for the first iteration has a highest resolution of the first characteristic and each level of the plurality of levels for each subsequent iteration has a resolution of the first characteristic that is less than a level of a preceding iteration.

6. The method of claim 1, wherein the raw data comprises a plurality of variables, wherein iteratively generating a plurality of intermediate data structures comprises:
grouping the segmented data items into a group for each of the plurality of variables, wherein executing the one or more transformation functions comprises executing the one or more transformation functions on the groups of segmented data items.

7. The method of claim 1, wherein the one or more transformation functions comprises a plurality of aggregation functions.

8. The method of claim 1, wherein the raw data comprises Controller-Area-Network (CAN) bus data.

9. The method of claim 1, wherein the raw data comprises time-series data.

10. The method of claim 1, wherein the raw data comprises a second characteristic, and wherein the plurality of levels are based on the first characteristic and the second characteristic.

11. A system comprising:
a memory storing instructions; and
one or more processors communicably coupled to the memory and configured to execute the instructions to:
obtain raw data from sensors of one or more vehicles, wherein the raw data comprises a first characteristic;
iteratively generate a plurality of intermediate data structures by segmenting data items of an input data structure according to a plurality of levels of the first characteristic and, for each level, executing one or more transformation functions on the segmented data items to generate a respective intermediate data structure of the plurality of intermediate data structures, wherein the input data structure for a first iteration comprises the raw data and the input data structure for subsequent iterations is an intermediate data structure generated by a preceding iteration;
combine the plurality of intermediate data structures to generate a cascaded data structure; and
train a machine learning model using the cascaded data structure.

12. The system of claim 11, wherein the first characteristic comprises at least one of a temporal characteristic and a spatial characteristic.

13. The system of claim 11, wherein each intermediate data structure of the plurality of intermediate data structures corresponds to a level of the plurality of levels.

14. The system of claim 11, wherein the plurality of levels are arranged in an hierarchical order, wherein a level of the plurality of levels for the first iteration has a highest resolution of the first characteristic and each level of the plurality of levels for each subsequent iteration has a resolution of the first characteristic that is less than a level of a preceding iteration.

15. The system of claim 11, wherein the raw data comprises a plurality of variables, wherein iteratively generating a plurality of intermediate data structures comprises:
grouping the segmented data items into a group for each of the plurality of variables, wherein executing the one or more transformation functions comprises executing the one or more transformation functions on the groups of segmented data items.

16. The system of claim 11, wherein the raw data comprises Controller-Area-Network (CAN) bus data.

17. A server comprising:
a memory storing instructions; and
one or more processors communicably coupled to the memory and configured to execute the instructions to:
set a plurality of hierarchical levels of resolution based on a characteristic;
construct a cascaded data structure by iteratively segmenting data items of an input data structure according to the hierarchical levels of resolution and, for each level of the hierarchical levels of resolution, applying one or more aggregation functions to the segmented data items to generate one or more intermediate data structures that are combined to form the cascaded data structure; and
apply at least one intermediate data structure from the cascaded data structure as training data to a machine learning model,
wherein an input data structure for a first level of the hierarchical levels of resolution comprises raw sensor data collected by vehicles and an input data structure for subsequent levels of the hierarchical levels of resolution comprises an intermediate data structure associated with a preceding level of the hierarchical levels of resolution.

18. The server of claim 17, wherein the characteristic is at least one of a temporal characteristic and a spatial characteristic.

19. The server of claim 17, wherein each intermediate data structure of the ne or more intermediate data structures corresponds to a hierarchical level of the plurality of hierarchical levels.

20. The server of claim 17, wherein each intermediate data structure of the ne or more intermediate data structures corresponds to a hierarchical level of the plurality of hierarchical levels.

21. The server of claim 17, wherein the raw sensor data comprises a plurality of variables, wherein constructing the cascaded data structure comprises:
grouping the segmented data items into a group for each of the plurality of variables, wherein executing the one or more aggregation functions comprises executing the one or more aggregation functions on the groups of segmented data items.
